(19) United States
(12) Patent Application Publication
(10) Pub. No.: US 2024/0175714 A1
(43) Pub. Date: May 30, 2024

(54) METHOD FOR CHECKING A DIGITAL MAP OF AN ENVIRONMENT OF A MOTOR VEHICLE

(71) Applicant: Robert Bosch GmbH, Stuttgart (DE)

(72) Inventor: Andreas Heyl, Weil Der Stadt (DE)

(21) Appl. No.: 18/501,298

(22) Filed: Nov. 3, 2023

(30) Foreign Application Priority Data
Nov. 28, 2022 (DE) 10 2022 212 708.0

(51) Int. Cl. G01C 21/00

(52) U.S. Cl. CPC G01C 21/3889; G01C 21/3874

(57) ABSTRACT

A method for checking a digital map of an environment of a motor vehicle. The method includes: transmitting the digital map by the motor vehicle to an out-of-vehicle checking system via a communication network in order to check the digital map by means of the checking system; receiving, by the motor vehicle, an out-of-vehicle check result of the digital map from the checking system via the communication network; checking the digital map by the motor vehicle on the basis of environment sensor data representing the environment of the motor vehicle from an environment sensor system of the motor vehicle in order to ascertain an in-vehicle check result; comparing the out-of-vehicle check result with the in-vehicle check result in order to ascertain a comparison result; ascertaining at least one action to be carried out by the motor vehicle on the basis of the comparison result.

### CROSS REFERENCE

The present application claims the benefit under 35 U.S.C. § 119 of German Patent Application No. DE 10 2022 212 708.0 filed on Nov. 28, 2022, which is expressly incorporated herein by reference in its entirety.

### FIELD

The present invention relates to methods for checking a digital map of an environment of a motor vehicle, a device, a checking system, a computer program, and a machine-readable storage medium.

### BACKGROUND INFORMATION

U.S. Patent Application Publication No. US 2021/0310823 A1 describes a method for updating a map.
U.S. Patent Application Publication No. US 2020/0292329 A1 describes a method for updating a map.

### SUMMARY

An object of the present invention is to provide efficient checking a digital map of an environment of a motor vehicle.

This object may be achieved by means of features of the present invention. Advantageous embodiments of the present invention are disclosed herein.

According to a first aspect of the present invention, a method for checking a digital map of an environment of a motor vehicle is provided. According to an example embodiment of the present invention, the method comprises the following steps:
transmitting the digital map by the motor vehicle to an out-of-vehicle checking system via a communication network in order to check the digital map by means of the checking system,
receiving, by the motor vehicle, an out-of-vehicle check result of the digital map from the checking system via the communication network,
checking the digital map by the motor vehicle on the basis of environment sensor data representing the environment of the motor vehicle from an environment sensor system of the motor vehicle in order to ascertain an in-vehicle check result,
comparing the out-of-vehicle check result with the in-vehicle check result in order to ascertain a comparison result,
ascertaining at least one action to be carried out by the motor vehicle on the basis of the comparison result.

According to a second aspect of the present invention, a method for checking a digital map of an environment of a motor vehicle is provided. According to the example embodiment of the present invention, the method comprises the following steps:
receiving the digital map transmitted from the motor vehicle via a communication network by means of an out-of-vehicle checking system,
checking the received digital map on the basis of a digital reference map by means of the checking system in order to ascertain an out-of-vehicle check result,
transmitting the out-of-vehicle check result by means of the checking system to the motor vehicle via the communication network.

According to a third aspect of the present invention, a device is provided that is configured to carry out all the steps of the method according to the first aspect.

According to a fourth aspect of the present invention, a checking system is provided that is configured to carry out all the steps of the method according to the second aspect.

According to a fifth aspect of the present invention, a computer program is provided that comprises commands that, when a computer program is executed by a computer, for example by the device according to the third aspect and/or by the checking system according to the fourth aspect, causes the latter to carry out a method according to the first aspect and/or according to the second aspect.

According to a sixth aspect of the present invention, a machine-readable storage medium is provided on which the computer program according to the fifth aspect is stored.

The present invention is based on the finding and includes the fact that the above object may be achieved in that a digital map of an environment of a motor vehicle is checked both by the motor vehicle, i.e., internally to the motor vehicle, and externally to the motor vehicle. This results in the technical advantage, for example, that the digital map can be checked efficiently.

The digital map of the environment of the motor vehicle is thus present in the motor vehicle and is transmitted therefrom to an out-of-vehicle checking system. The out-of-vehicle checking system is thus advantageously efficiently enabled to check the digital map. A corresponding check result is transmitted back to the motor vehicle from the out-of-vehicle checking system. This results in the technical advantage, for example, that the motor vehicle is efficiently enabled to check both the check result by the motor vehicle and the out-of-vehicle check result, in the present case to compare them with one another, in order to ascertain a comparison result. On the basis of the comparison result, one or more actions to be carried out by the motor vehicle are ascertained. Such an action can thus be efficiently ascertained.

For example, if the comparison result indicates that the two check results match, in particular within a predefined tolerance, it is ascertained as an action, for example, that the digital map of the environment of the motor vehicle may be used for an operation of the motor vehicle. Otherwise, it is ascertained as an action, for example, that the digital map should or must not be used by the motor vehicle.

This may result in the technical advantage, for example, that the motor vehicle can be operated efficiently and safely.

In one example embodiment of the present invention, it is provided for out-of-vehicle metadata of the out-of-vehicle check result to be received by the motor vehicle from the checking system via the communication network, wherein at least one of the steps of the comparison and the ascertainment of the at least one action is carried out on the basis of the out-of-vehicle metadata.

This may result in the technical advantage, for example, that the comparison and/or the corresponding ascertainment can be carried out efficiently.

In one example embodiment of the present invention, it is provided for in-vehicle metadata of the in-vehicle check result to be ascertained by the motor vehicle, wherein at least one of the steps of the comparison and the ascertainment of the at least one action is carried out on the basis of the in-vehicle metadata.

This may result in the technical advantage, for example, that the corresponding step of the comparison and/or the corresponding step of the ascertainment can be carried out efficiently.

In one example embodiment of the present invention, it is provided for the metadata to describe one or more of the following information items: confidence of the check result, integrity of the check result, age of the check result, reliability of the check result with regard to a possible manipulation.

This may result in the technical advantage, for example, that particularly suitable metadata can be used.

In one example embodiment of the present invention, it is provided for the motor vehicle to be localized in the digital map by the motor vehicle in order to determine a location of the motor vehicle in the digital map, wherein the checking of the digital map by the motor vehicle is carried out on the basis of the determined location.

This may result in the technical advantage, for example, that the check can be carried out efficiently by the motor vehicle.

In one example embodiment of the present invention, it is provided for a location of the motor vehicle in the digital map to be received by the motor vehicle from the checking system via the communication network.

This may result in the technical advantage, for example, that the motor vehicle can localize itself on the basis of the received location in the digital map.

In one example embodiment of the present invention, it is provided for the location determined by the motor vehicle to be compared with the location received from the checking system in order to check the localization by the motor vehicle.

This may result in the technical advantage, for example, that the localization by the motor vehicle can be checked efficiently.

In one example embodiment of the present invention, it is provided for at least one of the steps of the comparison and the ascertainment of the at least one action to be carried out on the basis of the location received from the checking system.

This may result in a technical advantage, for example, that the corresponding comparison and/or the corresponding ascertainment can be carried out efficiently.

In one example embodiment of the present invention, if a comparison result indicates a deviation of the out-of-vehicle check result from the in-vehicle check result, it is provided for the ascertainment of the at least one action to comprise selecting at least one action from the following group of actions: transferring the motor vehicle into a safe state, temporary reduction of a performance of the motor vehicle, inclusion of the out-of-vehicle check result in the digital map.

This may result in a technical advantage, for example, that particularly suitable actions can be selected.

In one example embodiment of the present invention, it is provided for metadata of the out-of-vehicle check result to be ascertained by the checking system and transmitted by the checking system to the motor vehicle via the communication network.

This may result in a technical advantage, for example, that metadata can be made available to the motor vehicle efficiently. In particular, this also results in the technical advantage that the motor vehicle is efficiently enabled to use this out-of-vehicle metadata for steps of the method to be carried out by the motor vehicle.

In one example embodiment of the present invention, it is provided for the metadata to describe one or more of the following information items: confidence of the check result, integrity of the check result, age of the check result, reliability of the check result with regard to a possible manipulation.

This may result in a technical advantage, for example, that particularly suitable metadata can be used.

In one example embodiment of the present invention, it is provided for the motor vehicle to be localized in the digital map by the checking system in order to determine a location of the motor vehicle in the digital map, wherein the determined location is transmitted by the checking system to the motor vehicle via the communication network.

This may result in the technical advantage, for example, that the motor vehicle can efficiently localize itself on the basis of the location ascertained or determined by means of the checking system and/or can check its own localization.

In one example embodiment of the present invention, it is provided for the method according to the first aspect and/or the method according to the second aspect to be a computer-implemented method.

In one example embodiment of the present invention, it is provided for the method according to the first aspect to be executed or carried out by means of the device according to the third aspect.

Device features result analogously from corresponding method features, and vice versa.

In one example embodiment of the present invention, it is provided for the method according to the second aspect to be executed or carried out by means of the checking system according to the fourth aspect.

Technical functionalities of the checking system result analogously from corresponding technical functionalities of the method, and vice versa.

In one example embodiment of the present invention, it is provided for the device to be configured in terms of programming to execute the computer program according to the fifth aspect.

In one example embodiment of the present invention, it is provided for the checking system to be configured in terms of programming to execute the computer program according to the fifth aspect.

Technical functionalities and features of the method according to the first aspect result analogously from corresponding technical functionalities and features of the method according to the second aspect, and vice versa.

The wording “at least one” means “one or more”.

The checking system is, for example, part of a cloud infrastructure.

In one example embodiment of the present invention, features from embodiments relating to the method according to the first aspect and relating to the method according to the second aspect are provided.

In one example embodiment of the present invention, both the device according to the third aspect and the checking system according to the fourth aspect are provided.

Thus, for example, a system for checking a digital map of an environment of a motor vehicle is disclosed, which system comprises the device according to the third aspect and the checking system according to the fourth aspect.

For example, a method for checking a digital map of an environment of a motor vehicle is disclosed, which method comprises the method steps of the method according to the first aspect and the method steps of the method according to the second aspect.

The embodiments and examples of the present invention described in the description can be combined with one another in any form, even if this is not explicitly described.

The motor vehicle is, for example, an at least partially automated motor vehicle. Therefore, an at least partially automated guidance of the motor vehicle takes place, for example.

The wording “at least partially automated guidance” comprises one or more of the following cases: assisted guidance, partially automated guidance, highly automated guidance, fully automated guidance. The wording “at least partially automated” thus comprises one or more of the following formulations: assisted, partially automated, highly automated, fully automated.

Assisted guidance means that a driver of the motor vehicle continuously carries out either the lateral or longitudinal guidance of the motor vehicle. The respective other driving task (i.e., a control of the longitudinal or lateral guidance of the motor vehicle) is carried out automatically. This means that, with assisted guidance of the motor vehicle, either the lateral or the longitudinal guidance is controlled automatically.

Partially automated guidance means that in a specific situation (for example: driving on a freeway, driving within a parking lot, overtaking an object, driving within a lane defined by lane markings) and/or for a certain period of time a longitudinal and a lateral guidance of the motor vehicle are automatically controlled. A driver of the vehicle does not have to manually control the longitudinal and lateral guidance of the motor vehicle. However, the driver must continuously monitor the automatic control of the longitudinal and lateral guidance in order to be able to intervene manually if necessary. The driver must be prepared to fully take over the motor vehicle at any time.

Highly automated guidance means that for a certain period of time in a specific situation (for example: driving on a freeway, driving within a parking lot, overtaking an object, driving within a lane defined by lane markings), a longitudinal and a lateral guidance of the motor vehicle are automatically controlled. A driver of the vehicle does not have to manually control the longitudinal and lateral guidance of the motor vehicle. The driver does not have to continuously monitor the automatic control of the longitudinal and lateral guidance in order to be able to intervene manually if necessary. If required, a prompt to take over the control of the longitudinal and lateral guidance is automatically output to the driver, in particular output with a sufficient time reserve. The driver therefore potentially has to be able to take over the control of the longitudinal and lateral guidance. Limitations of the automatic control of the lateral and longitudinal guidance are automatically detected. In highly automated guidance, it is not possible to bring about a state of minimal risk automatically in every starting situation.

Fully automated guidance means that in a specific situation (for example: driving on a freeway, driving within a parking lot, overtaking an object, driving within a lane defined by lane markings), a longitudinal and a lateral guidance of the motor vehicle are automatically controlled. A driver of the vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is terminated, the driver is automatically prompted to take over the driving task (controlling the lateral and longitudinal guidance of the motor vehicle), in particular with a sufficient time reserve. If the driver does not take over the driving task, a return to a state of minimal risk is automatically made. Limitations of the automatic control of the lateral and longitudinal guidance are automatically detected. In all situations, it is possible to return to a system state of minimal risk automatically.

The present invention is explained in more detail below using preferred exemplary embodiments.

### BRIEF DESCRIPTION OF THE DRAWINGS

FIG. 1 shows a flowchart of a method according to the first aspect of the present invention.

FIG. 2 shows a flowchart of a method according to the second aspect of the present invention.

FIG. 3 shows a device according to an example embodiment of the present invention.

FIG. 4 shows a checking system according to an example embodiment of the present invention.

FIG. 5 shows a machine-readable storage medium according to an example embodiment of the present invention.

FIG. 6 shows a first block diagram according to an example embodiment of the present invention.

FIG. 7 shows two digital maps.

FIG. 8 shows a second block diagram according to an example embodiment of the present invention.

### DETAILED DESCRIPTION OF EXAMPLE EMBODIMENTS

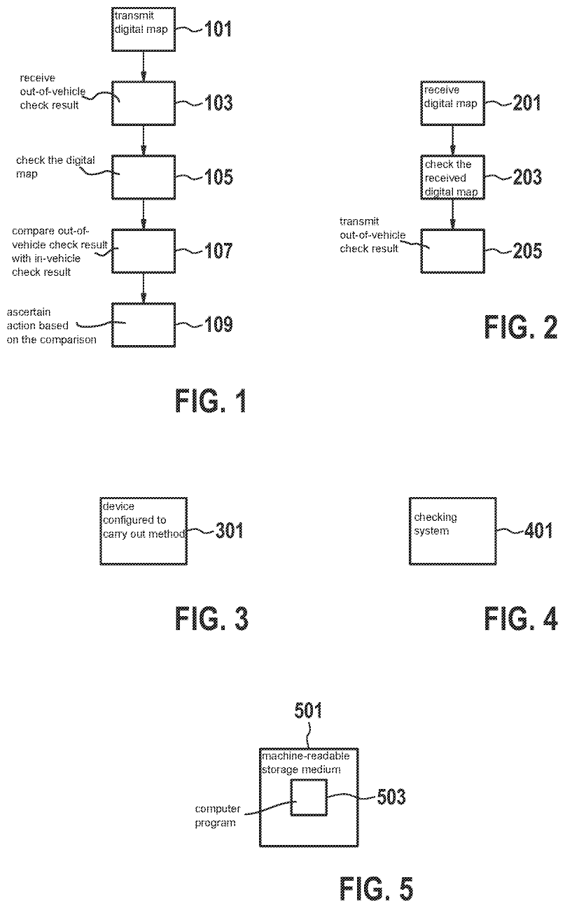

FIG. 1 shows a flowchart of a method for checking a digital map of an environment of a motor vehicle, comprising the following steps:
transmitting 101 the digital map by the motor vehicle to an out-of-vehicle checking system via a communication network in order to check the digital map by means of the checking system, receiving 103, by the motor vehicle, an out-of-vehicle check result of the digital map from the checking system via the communication network,
checking 105 the digital map by the motor vehicle on the basis of environment sensor data representing the environment of the motor vehicle from an environment sensor system of the motor vehicle in order to ascertain an in-vehicle check result, comparing 107 the out-of-vehicle check result with the in-vehicle check result in order to ascertain a comparison result, ascertaining 109 at least one action to be carried out by the motor vehicle on the basis of the comparison result.

In one embodiment, it is provided for the ascertained action or the ascertained actions to be carried out by the motor vehicle. In one embodiment, it is provided for a performance of the ascertained at least one action to be controlled by the motor vehicle.

FIG. 2 shows a flowchart of a method for checking a digital map of an environment of a motor vehicle, comprising the following steps:
receiving 201 the digital map transmitted from the motor vehicle via a communication network by means of an out-of-vehicle checking system,
checking 203 the received digital map on the basis of a digital reference map by means of the checking system in order to ascertain an out-of-vehicle check result,
transmitting 205 the out-of-vehicle check result by means of the checking system to the motor vehicle via the communication network.

A communication network within the meaning of the description comprises, for example, a wireless communication network. A wireless communication network comprises, for example, a WLAN network and/or a mobile radio network.

FIG. 3 shows a device 301 that is configured to carry out all the steps of the method according to the first aspect.

The device 301 comprises, for example, a communication interface (not shown), which is configured to execute or carry out the steps of transmitting and receiving. For example, the device 301 comprises a processing unit (not shown), which is configured to execute or carry out the steps of comparing, checking, and ascertaining. Such a processing unit comprises, for example, one or more processors and/or one or more computers.

FIG. 4 shows a checking system 401 that is configured to carry out all the steps of the method according to the second aspect.

The checking system 401 is an out-of-vehicle checking system. The checking system 401 comprises, for example, a communication interface (not shown), which is configured to execute or carry out the steps of transmitting and receiving. For example, the checking system 401 comprises a processing unit (not shown), which is configured to execute or carry out the step of checking. Such a processing unit comprises, for example, one or more processors and/or one or more computers.

FIG. 5 shows a machine-readable storage medium 501 on which a computer program 503 is stored. The computer program 503 comprises commands that, when the computer program 503 is executed by a computer, cause this computer to carry out a method according to the first aspect and/or according to the second aspect.

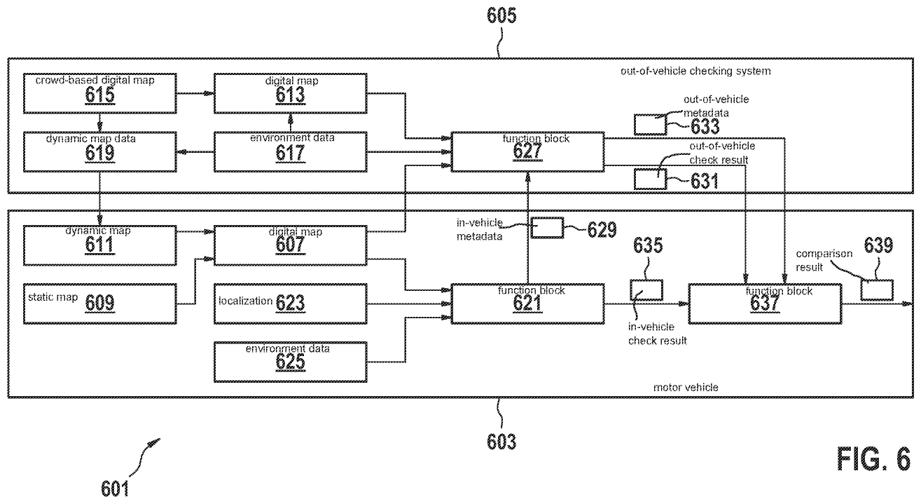

FIG. 6 shows a block diagram 601, which is intended to explain the concept described here for checking a digital map of an environment of a motor vehicle by way of example.

A first block with the reference sign 603 symbolically denotes the motor vehicle.

The reference sign 605 denotes a block which is intended to symbolically represent an out-of-vehicle checking system.

A digital map 607 of an environment of the motor vehicle 603 is present internally in the motor vehicle. This digital map 607 can, for example, comprise a static map 609 in which static objects of the environment of the motor vehicle are shown or indicated. Furthermore, the digital map 607 can comprise a dynamic map 611, which indicates dynamic objects in the environment of the motor vehicle.

The digital map 607 can thus indicate both static and dynamic objects in the environment of the motor vehicle.

A digital map 613, generated externally to the motor vehicle, of the environment of the motor vehicle is present in the checking system 605. This digital map 613 generated externally to the motor vehicle can subsequently also be referred to as a further digital map of the environment of the motor vehicle. The further digital map 613 can be generated, for example, on the basis of a crowd-based digital map 615. The crowd-based digital map 615 was thus generated or ascertained on the basis of data that were provided by a “crowd”, i.e., from a group or from a swarm. Furthermore, the further digital map 613 can be generated or ascertained on the basis of environment sensor data from infrastructure environment sensors, i.e., environment sensors of an infrastructure, wherein these environment sensor data describe an environment of the motor vehicle. These environment sensors of the infrastructure are thus spatially distributed within the infrastructure through which the motor vehicle 603 travels. On the basis of the crowd-based map 615 and/or on the basis of the environment data 617, dynamic map data 619, for example, can be generated or ascertained, which are transmitted to the motor vehicle 603 via a communication network. On the basis of these map data 619, the motor vehicle 603 can generate or ascertain the dynamic map 611 or update such a dynamic map.

The digital map 607 present in the motor vehicle is transmitted from the motor vehicle 603 to the checking system 605 via the communication network. The digital map 607 can be checked by the motor vehicle according to a function block 621, as described above and/or below. For example, a localization 623 ascertained by the motor vehicle is used for this check. For example, environment data 625 generated by the motor vehicle, which describe the environment of the motor vehicle, are used for this check. These environment data 625 generated or ascertained by the motor vehicle are based, for example, on environment detection of the motor vehicle using one or more environment sensors, i.e., an environment sensor system, of the motor vehicle 603.

An environment sensor within the meaning of the description is, for example, one of the following environment sensors: radar sensor, lidar sensor, ultrasonic sensor, magnetic field sensor, image sensor, in particular image sensor of a video camera, in particular stereo video camera.

The out-of-vehicle check of the digital map 607 is carried out in a function block 627. For this check, the out-of-vehicle checking system 605 uses the further digital map 613 and optionally the environment data 617. According to the function block 621, a check of the digital map 607 is therefore carried out by the motor vehicle. An in-vehicle check result is ascertained according to the function block 621. On the basis of the in-vehicle check result, in-vehicle metadata 629 of the in-vehicle check result are ascertained by the motor vehicle, and these metadata 629 ascertained by the motor vehicle are transmitted from the motor vehicle 603 to the out-of-vehicle checking system 605.

The out-of-vehicle checking system 605 can use this in-vehicle metadata 629 for the check of the out-of-vehicle digital map 607.

The checking system 605 thus ascertains an out-of-vehicle check result 631 corresponding to the check and transmits it to the motor vehicle 603 via the communication network. Furthermore, the checking system 605 can ascertain out-of-vehicle metadata 633 of the out-of-vehicle check result 631 and transmit them to the motor vehicle 603 via the communication network.

According to the function block 621, an in-vehicle check result 635 is thus ascertained.

According to a function block 637, the out-of-vehicle check result 631 is compared by the motor vehicle with the in-vehicle check result 635 in order to ascertain a comparison result 639. For this comparison according to the function block 637, the out-of-vehicle metadata 633, for example, and/or the in-vehicle metadata 629, for example, can be used.

The comparison result 639 is then used to ascertain at least one action to be carried out by the motor vehicle.

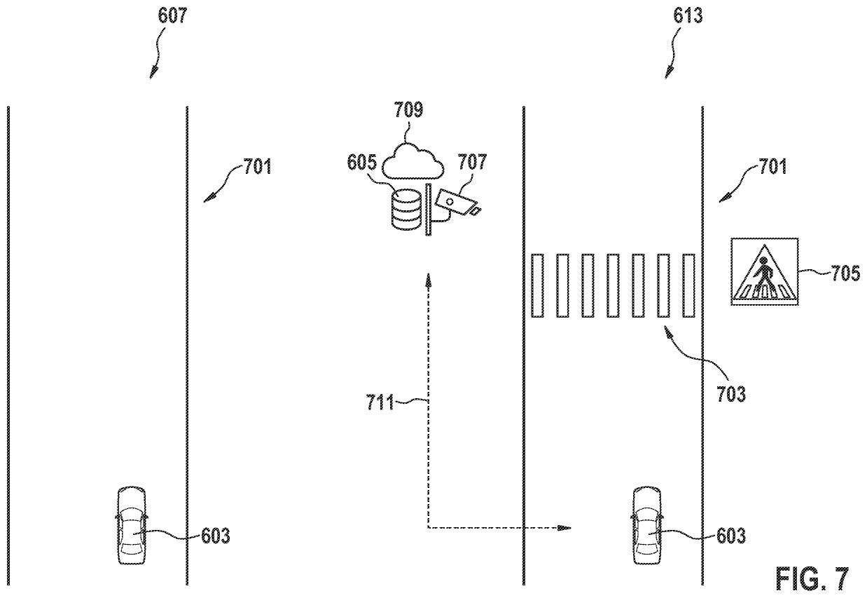

FIG. 7 shows the digital map 607 in an exemplary embodiment. The motor vehicle 603 has localized itself in the digital map 607. According to the digital map 607, the motor vehicle 603 drives on a road 701.

FIG. 7 also shows the further digital map 613 in an exemplary embodiment. The road 701 is also shown in the further digital map 613. However, in contrast to the digital map 607, a crosswalk 703 is also recorded, as well as a crosswalk traffic sign 705. A video camera 707, which is arranged on the road 701, has detected the crosswalk 703 and the crosswalk traffic sign 705. The corresponding video images are examples of environment data 617 according to the block diagram 601 of FIG. 6.

Furthermore, in FIG. 7, a cloud symbol having the reference sign 709 is shown, which is intended to represent a cloud infrastructure. The cloud infrastructure 709 can, for example, make the crowd-based map 615 available to the checking system 605.

The checking system 605 has a communication link with the motor vehicle 603, wherein this communication link is shown by a dashed double arrow with the reference sign 711. This is a wireless communication link.

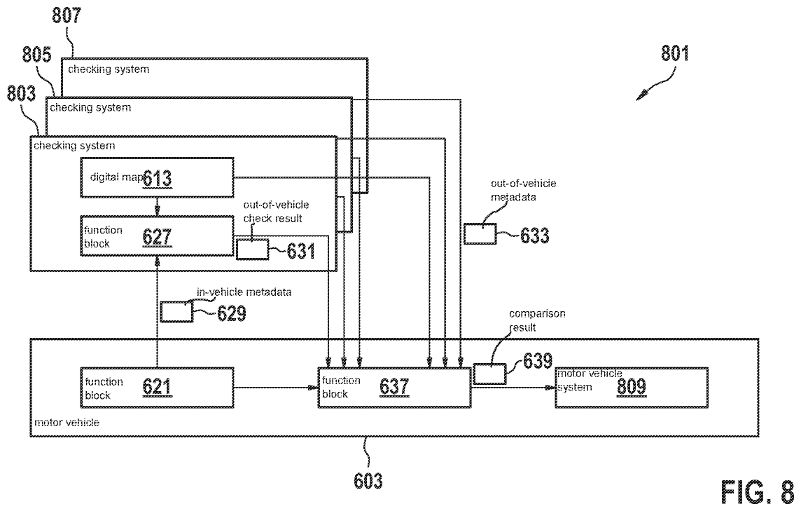

FIG. 8 shows a further block diagram 801, which is intended to explain the concept described here for checking a digital map of an environment of a motor vehicle by way of example.

The further block diagram 801 is similar to the block diagram 601 of FIG. 6 or is based on it. For the sake of clarity, not all function blocks or blocks as shown in block diagram 601 are shown in FIG. 8.

In contrast to the block diagram 601, multiple out-of-vehicle checking systems 803, 805, 807 are provided according to the further block diagram 801 of FIG. 8. Three such out-of-vehicle checking systems are shown by way of example here. In embodiments not shown, more or less than three out-of-vehicle checking systems are provided.

Analogously to block diagram 601, the motor vehicle 603 transmits the corresponding data to each of these out-of-vehicle checking systems 803, 805, 807. The out-of-vehicle checking systems 803, 805, 807 are constructed analogously to the out-of-vehicle checking system 605 or function in an analogous manner. Therefore, not all function blocks or blocks are shown.

The comparison result 639 ascertained by the motor vehicle is, for example, provided or transmitted to a motor vehicle system 809 or multiple motor vehicle systems. These further motor vehicle systems can then ascertain an action to be carried out by the motor vehicle on the basis of the comparison result. For example, according to the function block 637, it can be provided for it to be determined or defined, on the basis of the ascertained comparison result, whether the digital map 607 or the further digital map 613 is to be used for an operation of the motor vehicle 603.

For example, it is provided both in the block diagram 601 and in the further block diagram 801 for the further digital map 613 to be transmitted from the checking system 605 to the motor vehicle 603.

The concept described here describes an architecture for hybrid checking of the map information of an at least partially automated motor vehicle during operation, wherein the monitoring comprises an in-vehicle and an out-of-vehicle part.

The concept described here has, for example, the following advantages, wherein internal relates to the motor vehicle and external relates to the checking system.

Increasing safety: additional check by an out-of-vehicle checking system if the in-vehicle knowledge is insufficient, and this circumstance was not recognized in the vehicle.

Increasing robustness and availability: support for checking by an external checking system if the internal knowledge is insufficient and thus the internal uncertainty (e.g., temporarily) is so high that the checking system would have to be transferred into the safe state from outside without support. Availability of resources in the event of overload: shift of components of the check to external checking systems to internally free up resources for other functions.

Saving in-vehicle resources in the long term: If the check by an external system can take place sufficiently continuously (e.g., in portions along the route), an (A) SIL decomposition (e.g. ASIL B+ASIL B, ASIL C+ASIL A) can be applied so that the hardware and development complexity inside the motor vehicle can be saved—“(A) SIL” stands for: “(Automotive) Safety Integrity Level according to ISO 26262 or IEC 61508”.

Reducing the demands on the map update process of a fleet of motor vehicles: Instead of having to check and update maps with a high frequency completely and for the entire fleet, the check/plausibility check/update can first be limited to the local environment of the motor vehicle. However, the information can then also be used for a later fleet-wide update.

The internal check of the map information (digital map) takes place, for example, on the basis of the in-vehicle environment sensor system (e.g., lidar, radar, video), the internal localization and internal plausibility checking algorithms (e.g., plausibility checking of the map contents against the environment perceived by the perception system, plausibility checking of the consistency of map, perception, and localization).

The external monitoring by the checking system takes place, for example, on the basis of the externally available map (e.g., on the basis of data of a mapping fleet and/or crowd data, both static and dynamic content such as current friction values), external sensing (current data, e.g., via environment sensors installed in the infrastructure, such as video, radar, lidar, temperature, moisture, magnetic loop, piezo, etc.), and an external checking algorithm (e.g., superimposing the two map contents or focus on a comparison of map attributes classified as safety-critical—e.g., traffic light position, lane assignment, position of stop lines, direction of travel of a lane.

An in-vehicle device, which can also be referred to as a “hybrid map decider”, then determines whether the map information is correct according to internal and external monitoring. If the result of the check is negative, there are various options for mitigation, depending on the affected map attribute and/or potential safety relevance of the map attribute and/or the exact type of the deviation, e.g.:

Transferring the motor vehicle to the safe state by means of a safety system and/or the planner, e.g., via a fallback or emergency trajectory.

Temporarily reducing the performance of the motor vehicle by means of a safety system and/or the planner, e.g., reducing the speed of the vehicle, limiting the permitted maneuvers

Including the map information provided by the external checking system if said map information is evaluated internally as safe or, on the basis of the metadata, as more reliable.

The metadata comprise e.g.:

Confidence of the information (or uncertainty), e.g., on the basis of the input variables (e.g., current covariances of the environment sensor system used) and/or the calculation results (e.g., current uncertainty metrics of algorithms used (e.g., AI (artificial intelligence), DNN (“deep neural network”)).

Integrity of the information, e.g., how many redundant information sources (e.g., with a specific (A) SIL) were used, or the (A) SIL to which the monitoring function (software and hardware) corresponds.

Age of the information, e.g., the external information is still current enough for in-vehicle use due to high communication latency or which map data are more current.

Reliability of the information with regard to possible manipulations (“security”).

The hybrid check can, for example, take place continuously for the map portion and adjacent map portions in which the at least partially automated motor vehicle is located, or else in advance for the map portions that will be relevant in the next time periods according to the route planning, e.g., if no continuous wireless connection to the external checking system can be guaranteed.

The hybrid check, that is to say the check by the vehicle and the out-of-vehicle check, cannot be carried out for all map information, for example, but can be limited to the safety-relevant attributes in order to save, for example, bandwidth and resources.

The information about (all or only safety-critical) deviations discovered in the external checking system and/or in the hybrid check can be reported back from the checking system to a backend in order to initiate an investigation of the deviation and possibly adaptation of the map data there.

The hybrid check can also take place, for example, for map portions which have been driven through in the past and have been plausibility-checked internally in order, for example, to recognize deviations between the internal and the external map and to report them to the backend.

The hybrid check can also take place, for example, on the basis of more than one external checking system.

What is claimed is:

1. A method for checking a digital map of an environment of a motor vehicle, comprising the following steps:
transmitting the digital map by the motor vehicle to an out-of-vehicle checking system via a communication network to check the digital map using the checking system;
receiving, by the motor vehicle, an out-of-vehicle check result of the digital map from the checking system via the communication network;
checking the digital map by the motor vehicle based on environment sensor data representing the environment of the motor vehicle from an environment sensor system of the motor vehicle to ascertain an in-vehicle check result;
comparing the out-of-vehicle check result with the in-vehicle check result to ascertain a comparison result; and
ascertaining at least one action to be carried out by the motor vehicle based on the comparison result.

2. The method according to claim 1, wherein out-of-vehicle metadata of the out-of-vehicle check result are received by the motor vehicle from the checking system via the communication network, wherein at least one of the steps of the comparison and the ascertainment of the at least one action is carried out based on the out-of-vehicle metadata.

3. The method according to claim 1, wherein in-vehicle metadata of the in-vehicle check result are ascertained by the motor vehicle, wherein at least one of the steps of the comparison and the ascertainment of the at least one action is carried out based on the in-vehicle metadata.

4. The method according to claim 2, wherein the metadata describe one or more of the following information items: confidence of the check result, integrity of the check result, age of the check result, reliability of the check result with regard to a possible manipulation.

5. The method according to claim 1, wherein the motor vehicle is localized in the digital map by the motor vehicle to determine a location of the motor vehicle in the digital map, and wherein the checking of the digital map by the motor vehicle is carried out based on the determined location.

6. The method according to claim 1, wherein a location of the motor vehicle in the digital map is received by the motor vehicle from the checking system via the communication network.

7. The method according to claim 5, wherein a location of the motor vehicle in the digital map is received by the motor vehicle from the checking system via the communication network, and wherein the location determined by the motor vehicle is compared with the location received from the checking system to check the localization by the motor vehicle.

8. The method according to claim 6, wherein at least one of the steps of the comparison and the ascertainment of the at least one action is carried out based on the location received from the checking system.

9. The method according to claim 1, wherein, when the comparison result indicates a deviation of the out-of-vehicle check result from the in-vehicle check result, the ascertainment of the at least one action includes selecting at least one action from the following group of actions: transferring the motor vehicle into a safe state, temporary reduction of a performance of the motor vehicle, inclusion of the out-of-vehicle check result in the digital map.

10. A method for checking a digital map of an environment of a motor vehicle, comprising the following steps:
receiving the digital map transmitted from the motor vehicle via a communication network using an out-of-vehicle checking system;
checking the received digital map based on a digital reference map using the checking system to ascertain an out-of-vehicle check result; and
transmitting the out-of-vehicle check result using the checking system, to the motor vehicle via the communication network.

11. The method according to claim 10, wherein metadata of the out-of-vehicle check result are ascertained by the checking system and transmitted via the communication network to the motor vehicle by the checking system.

12. The method according to claim 11, wherein the metadata describe one or more of the following information items: confidence of the out-of-vehicle check result, integrity of the out-of-vehicle check result, age of the out-of-vehicle check result, reliability of the out-of-vehicle check result with regard to a possible manipulation.

13. The method according to claim 10, wherein the motor vehicle is localized in the digital map by the checking system to determine a location of the motor vehicle in the digital map, wherein the determined location is transmitted by the checking system to the motor vehicle via the communication network.

14. A device configured to check a digital map of an environment of a motor vehicle, the device configured to:
transmit the digital map by the motor vehicle to an out-of-vehicle checking system via a communication network to check the digital map using the checking system;
receive, by the motor vehicle, an out-of-vehicle check result of the digital map from the checking system via the communication network;
check the digital map by the motor vehicle based on environment sensor data representing the environment of the motor vehicle from an environment sensor system of the motor vehicle to ascertain an in-vehicle check result;
compare the out-of-vehicle check result with the in-vehicle check result to ascertain a comparison result; and
ascertain at least one action to be carried out by the motor vehicle based on the comparison result.

15. A checking system configured to check a digital map of an environment of a motor vehicle, the checking system being an out-of-vehicle checking system, the out-of-vehicle checking system configured to:
receive the digital map transmitted from the motor vehicle via a communication network using an out-of-vehicle checking system;
check the received digital map based on a digital reference map using the checking system to ascertain an out-of-vehicle check result; and
transmit the out-of-vehicle check result using the checking system, to the motor vehicle via the communication network.

16. A non-transitory machine-readable storage medium on which is stored a computer program for checking a digital map of an environment of a motor vehicle, the computer program, when executed by a computer, causing the computer to perform the following steps:
transmitting the digital map by the motor vehicle to an out-of-vehicle checking system via a communication network to check the digital map using the checking system;
receiving, by the motor vehicle, an out-of-vehicle check result of the digital map from the checking system via the communication network;
checking the digital map by the motor vehicle based on environment sensor data representing the environment of the motor vehicle from an environment sensor system of the motor vehicle to ascertain an in-vehicle check result;
comparing the out-of-vehicle check result with the in-vehicle check result to ascertain a comparison result; and
ascertaining at least one action to be carried out by the motor vehicle based on the comparison result.
